(19) United States
(12) Patent Application Publication
(10) Pub. No.: US 2025/0005988 A1
(43) Pub. Date: Jan. 2, 2025

(54) COIN PROCESSING DEVICE AND METHOD OF CONTROLLING COIN PROCESSING DEVICE

(71) Applicant: GLORY LTD., Hyogo (JP)

(72) Inventors: Yusuke YOSHIDA, Hyogo (JP); Shuji ONISHI, Hyogo (JP)

(21) Appl. No.: 18/756,095

(22) Filed: Jun. 27, 2024

(30) Foreign Application Priority Data
Jun. 30, 2023 (JP) 2023-108398

(51) Int. Cl. G07D 1/06

(52) U.S. Cl. CPC G07D 1/06; G07D 2201/00

(57) ABSTRACT

A coin processing device includes: a first storage and a second storage each configured to store a coin; a transport configured to transport the coin; an outlet configured to dispense the coin to outside; and a controller configured to execute a first operation of transmitting the coin stored in the first storage so as to store the coin in the second storage, and a second operation of dispensing the coin stored in the second storage from the outlet, wherein the controller executes the first operation in a period after execution of the second operation until a start of the next second operation, and wherein a timing of execution of the first operation can be changed in a period after execution of the second operation until a start of the next second operation.

### TECHNICAL FIELD

The present disclosure relates to a coin processing device and a method of controlling the coin processing device.

### BACKGROUND ART

In the related art, money processing devices that perform money depositing/dispensing processes are installed in stores and the like. A money processing device switches the operation mode between a first mode (normal mode) for driving the transport path for transporting money at a first transport speed, and a second mode (eco mode) for driving the transport path at a second transport speed slower than the first transport speed, and drives the transport path at the speed corresponding to the switched operation mode.

The operation mode is switched on the basis of factors (internal factors) caused in the money processing device itself and factors (external factors) outside the money processing device. The money processing device achieves fast processing with the first mode, and power saving and noise reduction with the second mode.

### SUMMARY

A coin processing device according to the present disclosure comprises: a first storage and a second storage each configured to store a coin; a transport configured to transport the coin; an outlet configured to dispense the coin to outside; and a controller configured to execute a first operation of transmitting the coin stored in the first storage so as to store the coin in the second storage, and a second operation of dispensing the coin stored in the second storage from the outlet, wherein the controller executes the first operation in a period after execution of the second operation until a start of the next second operation, and wherein a timing of execution of the first operation can be changed in a period after execution of the second operation until a start of the next second operation.

### BRIEF DESCRIPTION OF DRAWINGS

FIG. 1 is a diagram illustrating a positional relationship between a coin processing device of Embodiment 1 and the user;

FIG. 2 is a conceptual view illustrating an example of a configuration of the coin processing device of Embodiment 1;

FIG. 3 is a diagram illustrating an example of a structure of a feeding part of Embodiment 1;

FIG. 4 is a flowchart illustrating an example of a setting procedure for the timing of execution of a preparation operation performed by the coin processing device;

FIG. 5A is a diagram illustrating a screen display for setting a given elapsed time;

FIG. 5B is a diagram illustrating a screen display for selecting and setting elapsed times;

FIG. 5C is a diagram illustrating a screen display for selecting settings from options;

FIG. 6 is a flowchart illustrating an example of a processing procedure of a dispensing process performed by the coin processing device; and

FIG. 7 is a flowchart illustrating an example of a processing procedure of an error determination process performed by a coin processing device 1.

### DESCRIPTION OF EMBODIMENTS

Embodiments of the present disclosure are described below with reference to the drawings. Note that embodiments described below are specific examples of the present disclosure. Therefore, the components, arrangements and connections of components, steps, the order of the steps and the like described in following embodiments are merely examples, and do not limit the present disclosure. Therefore, the components described in the following embodiments that are not recited in the independent claim are described as optional components.

Each drawing is a schematic diagram and is not necessarily strictly illustrated. In each drawing, the same symbol is attached to a substantially identical configuration, and redundant explanations are omitted or simplified.

In the coin processing device according to the present disclosure, the control part may acquire information about a timing of execution of the first operation input by a user through an input part, and set the timing of execution of the first operation in accordance with the information acquired.

In the coin processing device according to the present disclosure, the control part may cause the input part to display a screen configured to input a time from completion of the second operation to a start of the first operation.

In the coin processing device according to the present disclosure, the control part may cause the input part to display a time from completion of the second operation to a start of the first operation in a selectable manner from among a plurality of predetermined times.

In the coin processing device according to the present disclosure, the control part may cause the input part to display the information about the timing of execution of the first operation in a selectable manner from among a plurality of options.

In the coin processing device according to the present disclosure, as the plurality of options, the control part may cause the input part to display in a selectable manner at least execution of the first operation after an elapse of a predetermined time after completion of the second operation, or execution of the first operation consecutively from the second operation.

In the coin processing device according to the present disclosure, the control part may acquire information about an input of the user on an order input part configured to receive an input for transaction, and as the plurality of options, the control part may cause the input part to display in a selectable manner at least execution of the first operation while the user performs input on the order input part.

In the coin processing device according to the present disclosure, the control part may set a time until a start of the first operation after the second operation.

In the coin processing device according to the present disclosure, the control part may set the timing of execution of the first operation from among a plurality of options.

In the coin processing device according to the present disclosure, the control part may set execution of the first operation after an elapse of a predetermined time after completion of the second operation.

In the coin processing device according to the present disclosure, the control part may set execution of the first operation consecutively from the second operation.

In the coin processing device according to the present disclosure, the control part may set the timing of execution of the first operation in accordance with frequency of the second operation.

In the coin processing device according to the present disclosure, in a case where the frequency is lower than a predetermined level, the control part may execute the first operation when a predetermined time has elapsed after completion of the second operation, and in a case where the frequency is higher than the predetermined level, the control part may execute the first operation consecutively from the second operation.

The coin processing device according to the present disclosure may further comprise: a feeding part configured to feed the coin to the transport path; and a remaining object sensor disposed at the feeding part and configured to detect a remaining object inside the feeding part, in which when the remaining object is detected by the remaining object sensor, the control part may determine whether to determine the remaining object to be an error in accordance with details of a process that is being executed.

A method of controlling the coin processing device according to the present disclosure comprises: storing, from a first storage part configured to store coins, at least some of the coins in a second storage part by transporting the at least some of the coins from the first storage part; and dispensing from an outlet at least some of coins stored in the second storage part, in which the storing is executed in a period after execution of the dispensing until a start of the next dispensing, and in which a timing of execution of the storing is changeable in a period after execution of the dispensing until a start of the next dispensing.

The coin processing device according to the present disclosure comprises a first storage part and a second storage part each configured to store a coin; a transport part configured to transport the coin; an outlet configured to dispense the coin to outside; and a control part configured to execute a preparation operation of transmit the coin stored in the first storage part so as to store the coin in the second storage part, and a dispensing operation of dispensing the coin stored in the second storage part from the outlet. The control part executes the preparation operation in a period after execution of the preparation operation until a start of the next dispensing operation. A timing of execution of the preparation operation is changeable in a period after execution of the dispensing operation until a start of the next dispensing operation.

In the coin processing device according to the present disclosure, the control part may acquire the information about the timing input by the administrator, and set the timing in accordance with the acquired information.

In the coin processing device according to the present disclosure, the control part may set the time from the completion of the dispensing operation to the start of the preparation operation.

In the coin processing device according to the present disclosure, the control part may select the timing of execution of the preparation operation from among a plurality of timings.

In the coin processing device according to the present disclosure, as the timing of execution of the preparation operation, the control part may select the timing when the user is inputting information.

In the coin processing device according to the present disclosure, as the timing of execution of the preparation operation, the control part may select the timing when a predetermined time has elapsed after the completion of the dispensing operation.

In the coin processing device according to the present disclosure, as the timing of execution of the preparation operation, the control part may select the timing when the preparation operation is executed consecutively from the dispensing operation.

In the coin processing device according to the present disclosure, the control part may set the timing of execution of the preparation operation in accordance with the frequency of the dispensing operation.

In the coin processing device according to the present disclosure, when the frequency is lower than a predetermined level, the control part may set the timing of execution of the preparation operation to the timing when a predetermined time has elapsed from the completion of the dispensing operation, and when the frequency is higher than the predetermined level, the control part may set the timing of execution of the preparation operation to the timing when the preparation operation is executed consecutively from the dispensing operation.

In the coin processing device according to the present disclosure, the timing of execution of the preparation operation may be changed within the upper limit range designated for the elapsed time after the completion of the dispensing operation.

The coin processing device according to the present disclosure may further comprise a Kiosk terminal, and, as the timing of execution of the preparation operation, the control part may select one of the timing when the user is inputting information, the timing when a predetermined time has elapsed after the completion of the dispensing operation, and the timing when the preparation operation is executed consecutively from the dispensing operation.

The coin processing device according to the present disclosure may be composed of a member separately provided from a Kiosk terminal. When operation information of the user cannot be acquired from the Kiosk terminal, the control part may select, as the timing of execution of the preparation operation, the timing when a predetermined time has elapsed after the completion of the dispensing operation, and the timing when the preparation operation is executed consecutively from the dispensing operation.

In the coin processing device according to the present disclosure, the timing of execution of the first operation may be changed in accordance with output signals from various sensors. For example, information about the surrounding environment may be determined in accordance with an output signal from a sound level sensor and/or an image sensor so as to change the timing of execution of the first operation. In addition, in the coin processing device according to the present disclosure, the control part may set the timing of execution of the preparation operation in accordance with the sound level in the surrounding region.

In the coin processing device according to the present disclosure, the control part may set the timing of execution of the preparation operation when the sound level in the surrounding region is smaller than the predetermined level.

In the coin processing device according to the present disclosure, the control part may execute the preparation operation at the timing when the absence of people in the surrounding region is detected.

In the coin processing device according to the present disclosure, only when the frequency of the dispensing operation is lower than a predetermined level, the control part may execute the preparation operation at the timing when the absence of people in the surrounding region is detected.

In the coin processing device according to the present disclosure, the control part may set the timing of execution of the preparation operation in accordance with the crowdedness of the store.

The coin processing device according to the present disclosure may further comprise a feeding part configured to feed the coin to the transport path, and a remaining object sensor disposed at the feeding part and configured to detect a remaining object inside the feeding part, in which when a remaining object is detected by the remaining object sensor, the control part may determine whether to determine the remaining object to be an error in accordance with the details of the process to be executed.

In the coin processing device according to the present disclosure, the detection of the remaining object may be achieved by detecting a fact that the light emitted by the remaining object sensor is blocked for a predetermined time or longer.

In the coin processing device according to the present disclosure, the control part may not determine the remaining object to be an error for a process operated by a general user, and may determine the remaining object to be an error for a process operated by the administrator.

The coin processing device according to the present disclosure may comprise another remaining object sensor separately provided from the above-described remaining object sensor, and the control part may detect a remaining coin by the other remaining object sensor when determining that the remaining object to be not an error.

In a coin processing device comprising a first storage part and second storage part configured to store a coin, a method of controlling the coin processing device according to the present disclosure comprises a first dispensing step of dispensing the coin stored in the second storage part from the outlet, a preparation step of transporting the coin from the first storage part to store the coin in the second storage part, and a second dispensing step of dispensing the coin stored in the second storage part from the outlet. The timing of execution of the preparation step can be changed in the period after the completion of the first dispensing step until the start of the second dispensing step.

### Embodiment 1

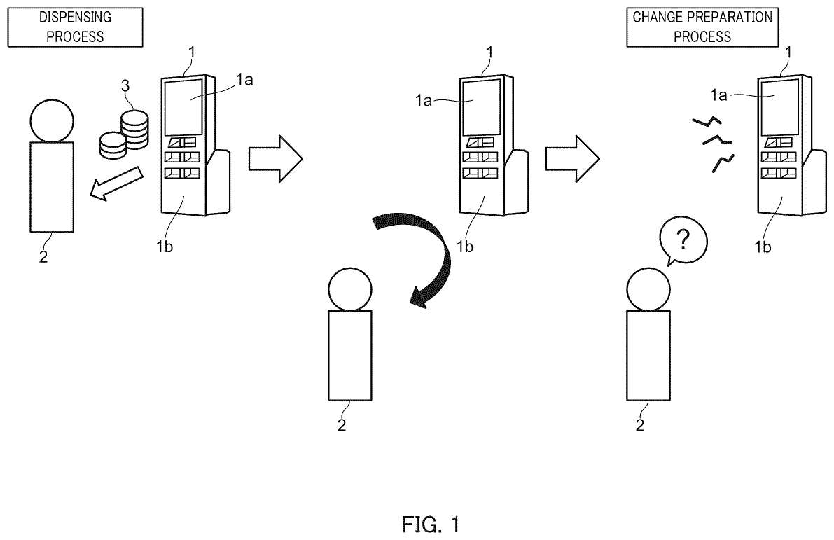

FIG. 1 is a diagram illustrating a positional relationship between a coin processing device 1 of Embodiment 1 and a user 2. The user 2 is a general user who uses the coin processing device 1 to purchase goods and receive service.

The coin processing device 1 comprises an input/output part 1a and a coin processing part 1b. The input/output part 1a is a touch panel display device that displays details of goods and service and the like, and receives from the user 2 selection of goods and service, and input operations related to transactions, for example. Thereafter, the user 2 can purchase goods and receive service by depositing money into the coin processing device 1. The input/output part 1a is an example of the order input part.

The coin processing part 1b is a device that performs coin depositing operation and coin dispensing operation. Note that a device that performs banknote depositing operation and banknote dispensing operation may be further provided. For example, the coin processing part 1b performs a preparation operation (first operation) and a dispensing operation (second operation) described below.

The preparation operation is an operation of transporting to and stores in a second storage part some of coins stored in a first storage part described later, and preparing a change 3 in the coin processing device 1 (first operation). The dispensing operation is an operation of dispensing at least some of coins stored in the second storage part from the outlet as the change 3 (second operation).

As illustrated in FIG. 1, the coin processing device 1 is installed in a store, for example. When the user 2 pays for purchased goods or the like at the coin processing device 1, the coin processing device 1 determines whether it is necessary to give the user 2 the change 3, and when it is necessary to give the change 3, the coin processing device 1 performs the dispensing operation of dispensing the change 3. Then, the user 2 receives the change 3 from the coin processing device 1.

After receiving the change 3, the user 2 moves away from the coin processing device 1.

The coin processing device 1 adjusts the timing of execution of the preparation operation in the period after the completion of the last the dispensing operation and before the start of the next dispensing operation. For example, the timing of execution of the preparation operation or the condition for execution of the preparation operation can be changed.

The setting of the timing of execution of the preparation operation is executed when an input/output part described later of the coin processing device 1 receives setting information input by the managing user of the coin processing device 1 of the store, for example.

The coin processing device 1 may acquire the setting information input by the managing user of the coin processing device 1 by communicating with the managing server that manages the coin processing device 1. The setting information input by the managing user may be acquired through communication with a mobile terminal operated by the managing user. The mobile terminal is an example of the input part.

In the case where a Kiosk terminal comprising a touch panel and an operation button is provided separately from the coin processing device 1, the coin processing device 1 may acquire the information input by the managing user of the coin processing device 1 by communicating with the Kiosk terminal. In this case, the Kiosk terminal is an example of the input part.

Further, the coin processing device 1 sets the timing of execution of the preparation operation in accordance with the setting information received from the managing user of the coin processing device 1.

The managing user of the coin processing device 1 can set the time to the execution of the preparation operation after the dispensing operation by an input operation at the input part. For example, the seconds and/or minutes elapsed after the dispensing operation may be arbitrarily set as the timing of execution of the preparation operation. For example, the elapsed time after the dispensing operation until execution of the preparation operation may be set by displaying on the input part settings of a plurality of predetermined times, and selecting the desired time from the display. It is possible to set a setting such that the preparation operation is executed after the user 2 is sufficiently away from the coin processing device 1 in the case where a sufficient time has elapsed after the completion of the dispensing operation.

While in the coin processing device 1, the timing of execution of the preparation operation can be changed in the period after the last dispensing operation and before the start of the next dispensing operation as described above, the coin processing device 1 selects the timing of execution of the preparation operation from among the following three settings, for example. Setting 1: When the user 2 is inputting information for transaction such as an order of goods or the like. Setting 2: When a predetermined time has elapsed after the completion of the dispensing operation. The predetermined time is a time sufficient enough to expect that the user 2 has moved away from the coin processing device 1, for example. Setting 3: When the preparation operation is executed consecutively from the dispensing operation.

The setting 1 is a setting for performing the preparation operation of preparing the change 3 while the user 2 is inputting information through the order input part for the purpose of an order of goods or the like, for example. After the coin processing device 1 has performed the dispensing operation of dispensing the change 3 in the transaction of the previous user 2, the preparation operation is executed while the next user 2 is ordering goods or the like in the next transaction, and the change 3 is supplied to the second storage part that temporarily stores the change 3.

Thereafter, when it is necessary to give the user 2 the change 3, the dispensing operation is performed by using the prepared change 3. In this manner, by performing the preparation operation while the user 2 inputs information, it is possible to prevent the user 2 from mistakenly believing that the user 2 has forgotten to pick up the change 3 or wondering what the sound is. This setting has the advantage that the dispensing operation is completed quickly.

The setting 2 is a setting for performing the preparation operation after a sufficient time interval after the completion of the dispensing operation. In the case where a sufficient time has elapsed after the completion of the dispensing operation, it can be expected that the user 2 is sufficiently away from the coin processing device 1, and therefore in that state the preparation operation is executed.

In this case, it is possible to prevent the user 2 from mistakenly believing that the user 2 has forgotten to pick up the change 3 or wondering what the sound is. This setting has the advantage that the dispensing operation is completed quickly, and that the next dispensing operation can be immediately performed after accepting the deposit.

The setting 3 is a setting for performing the preparation operation consecutively from the dispensing operation. Through the consecutive operations of performing the preparation operation with no interval after the completion of the dispensing operation, the preparation operation can be completed while the user 2 is conscious of the operation of the coin processing device 1.

In this case, it is possible to prevent the user 2 from mistakenly believing that the user 2 has forgotten to pick up the change 3 or wondering what the sound is. This setting has the advantage that the next dispensing operation can be immediately performed.

Note that the predetermined time in the setting 2 comprises a time that is arbitrarily set by the user 2 after the completion of the dispensing operation.

The managing user of the coin processing device 1 can set the timing of execution of the preparation operation by selecting it from among a plurality of options. For example, at least one of the settings 1 to 3 can be provided as options to be selected so as to set the timing of execution of the preparation operation. For example, at least one of the settings 1 to 3 can be displayed on the input part in a selectable manner such that the timing of execution of the preparation operation is set in accordance with the selection operation of the managing user. The managing user can select the desired setting in accordance with the store information.

While in the above description the coin processing device 1 changes the timing of execution of the preparation operation by receiving the input operation of the managing user of the coin processing device 1, the timing may be changed in accordance with the crowdedness of the store that is determined on the basis of the frequency of the transaction performed by the coin processing device 1, the number of times of the opening/closing of the automatic door installed in the store where the coin processing device 1 is operated, the camera images in the store, and the like.

For example, when the crowdedness of the store is lower than a predetermined level, the coin processing device 1 sets the time from the completion of the dispensing operation to the start of the preparation operation to a long time and executes the preparation operation after the user 2 has been sufficiently away from the coin processing device 1, so as to prevent the operating sound of the preparation operation from drawing attention of the user 2 after the completion of the transaction.

When the crowdedness of the store is higher than the predetermined level, on the other hand, the coin processing device 1 may set the time from the completion of the dispensing operation to the start of the preparation operation to a short time. This can reduce the crowdedness by quickly completing the transaction.

In addition to this, the coin processing device 1 may automatically change the setting of the timing of execution of the preparation operation in accordance with the frequency of the dispensing operation.

For example, when the frequency of the dispensing operation is lower than a predetermined level, the coin processing device 1 sets a setting such that the preparation operation is executed when a predetermined time has elapsed after the completion of the dispensing operation as with the setting 2. The predetermined time is a time with which it can be expected that the user 2 is sufficiently away from the coin processing device 1.

When the frequency is higher than the above-mentioned predetermined level, the coin processing device 1 sets a setting of performing the preparation operation consecutively from the dispensing operation as with the setting 3. In this manner, it is possible to prepare for the next dispensing operation by quickly performing the preparation operation while preventing the operating sound of the preparation operation from drawing attention of the user 2 after the completion of the transaction.

A control part 16 of the coin processing device 1 may acquire information about the sound level around the coin processing device 1 so as to change the timing of execution of the preparation operation in accordance with the sound level around the coin processing device 1.

For example, when the sound level is smaller than the predetermined level, the coin processing device 1 sets a setting of performing the preparation operation with a predetermined time interval after the completion of the dispensing operation. The predetermined time is a time with which it can be expected that the user 2 is sufficiently away from the coin processing device 1.

On the other hand, when the sound level is greater than the above-mentioned predetermined level, the user 2 does not mind the operating sound, and therefore the preparation operation may be performed at any time.

In the case where the installation environment of the coin processing device 1 is an environment where the user 2 does not mind the operating sound, the coin processing device 1 may set the timing of execution of the preparation operation to the timing when the user 2 is inputting information for transaction such as an order of goods as with the setting 1, or to the timing when the preparation operation is executed consecutively from the dispensing operation as with the setting 3.

The installation environment of the coin processing device 1 where the user 2 does not mind the operating sound is an environment of a crowded store or an environment with a high noise level, for example.

For example, the coin processing device 1 can determine the crowdedness of the store on the basis of information about the frequency of the transaction performed by the coin processing device 1, information about the number of times of the opening/closing of the automatic door installed in the store where the coin processing device 1 is operated, analysis results of the camera images in the store, and the like. In addition, the coin processing device 1 can determine the noise level on the basis of the noise level detected by a microphone.

When the crowdedness of the store is high, or when the noise level is high, the coin processing device 1 sets the setting such that the preparation operation is executed when the user 2 is inputting information for transaction such as an order of goods as with the setting 1, or that the preparation operation is executed consecutively from the dispensing operation as with the setting 3.

In this case, the user 2 does not mind much the operating sound even at the coin processing device 1, and therefore the preparation operation is set to be executed in the setting 1 or the setting 3 where the preparation operation is completed quickly.

When the interval of the depositing/dispensing process is equal to or greater than a predetermined time, the coin processing device 1 may set the setting such that the preparation operation is executed when a predetermined time has elapsed after the completion of the dispensing operation as with the setting 2. The predetermined time comprises elapsed times arbitrarily set by the user 2.

When the interval of the depositing/dispensing process is equal to or greater than the predetermined time, it can be expected that the store is not so crowded and that the noise level is low, and therefore the preparation operation is executed after the elapse of a predetermined time when it can be expected that the user 2 is sufficiently away from the coin processing device 1.

The coin processing device 1 may set the time for executing the preparation operation after the elapse of the completion of the dispensing operation within the upper limit range designated by the administrator of the coin processing device 1 regarding the elapsed time after the completion of the dispensing operation.

In this manner, it is possible to prepare for the next dispensing operation by limiting the time for executing the preparation operation after the elapse of the completion of the dispensing operation.

In the case where the coin processing device 1 is integrated with a Kiosk terminal, the coin processing device 1 may receive from the managing user of the coin processing device 1 selection of the setting from among the settings 1 to 3.

In the case where the coin processing device 1 is provided separately from a Kiosk terminal and the coin processing device 1 cannot acquire the operation information of the user 2 from the Kiosk terminal, selection of the setting 2 or the setting 3 may be received from the administrator of the coin processing device 1.

A camera for capturing a region around the coin processing device 1 may be provided such that the coin processing device 1 executes the preparation operation by detecting the absence of people around the coin processing device 1 through analysis of images captured by the camera.

The detection of the absence of people around the coin processing device 1 for the user 2 may be performed by a method other than the method using images captured by a camera, such as a method using a human sensor, for example.

In addition, the coin processing device 1 may perform this process only when the frequency of the dispensing operation of the coin processing device 1 is smaller than a predetermined level. The reason for this is that the next dispensing process may be affected if the coin processing device 1 does not perform the preparation operation until the user 2 moves away from the coin processing device 1 in the case where the store is crowded.

The coin processing device 1 may analyze images in the store captured by a camera to determine the crowdedness in the store such that the preparation operation is executed when it is detected that the crowdedness is lower than a predetermined level.

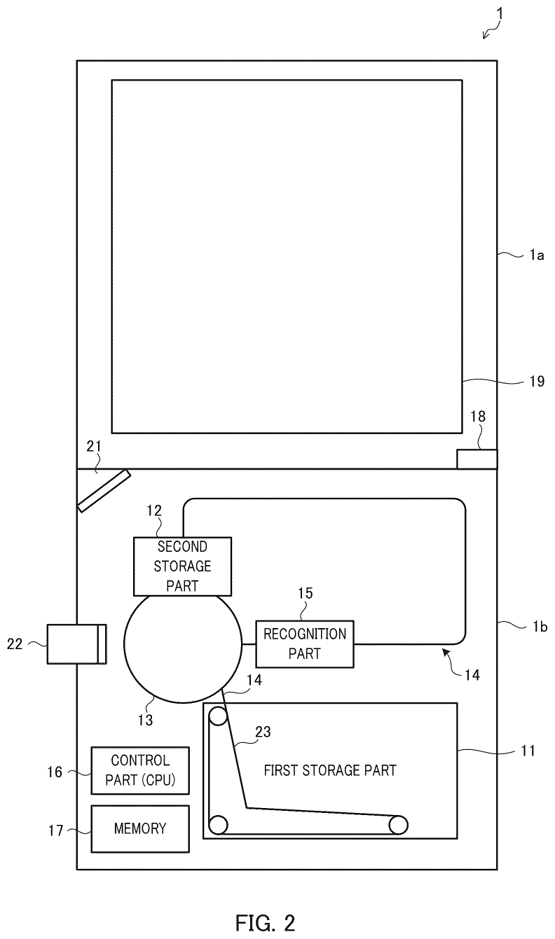

FIG. 2 is a conceptual diagram illustrating an example of a configuration of the coin processing device 1 of Embodiment 1. As described above with reference to FIG. 1, the coin processing device 1 comprises the input/output part 1a and the coin processing part 1b.

The input/output part 1a comprises a sound output part 18 and a touch-panel display device 19, for example. The input/output part 1a is an example of the order input part.

The sound output part 18 is a speaker that outputs sound. The display device 19 is a display device integrally composed of a touch panel and a liquid crystal display or an organic EL display, for example.

The coin processing part 1b comprises the first storage part 11, the second storage part 12, a feeding part 13, a transport part 14, a recognition part 15, the control part (CPU) 16, a memory 17, an inlet 21, an outlet 22, and an ejection mechanism 23.

The first storage part 11 stores coins of a plurality of denominations in a mixed manner. The first storage part 11 can eject the stored coin by the ejection mechanism 23 described later. The coin is ejected from the first storage part 11 to the feeding part 13, for example.

The second storage part 12 stores coins of a plurality of denominations in a mixed manner. The second storage part 12 can eject the stored coin. The coin is ejected from the second storage part 12 to the feeding part 13, for example.

Some of the plurality of coins stored in the first storage part 11 that are ejected from the first storage part 11 are stored in the second storage part 12. The coin stored in the second storage part 12 is used for dispensing, for example, change fund.

The feeding part 13 feeds one by one to the transport part 14 the coin ejected from the first storage part 11 or the second storage part 12. The feeding part 13 is provided near the second storage part on the lower side of the second storage part 12, for example. In this manner, the coin ejected from the second storage part 12 is immediately input to the feeding part 13, and thus the feeding from the second storage part 12 to the transport part 14 can be quickly performed.

The transport part 14 transports coins along the transport path between the feeding part 13, the first storage part 11, the second storage part 12, and the outlet. The transport part 14 transports coins along the transport path by using a belt and a motor, for example.

The recognition part 15 is a device that recognizes the denomination, authentication, fitness and the like of the coin transported by the transport part 14. The recognition part 15 may have a function of counting the number of the coins transported by the transport part 14. The recognition part comprises, for example, an optical sensor such as a camera. At least one of the denomination, authentication, fitness and the like of the coin are recognized on the basis of the image information acquired by the sensor.

The CPU (Central Processing Unit) 16 serving as the control part is a processor that controls the operation of each part of the coin processing device 1. The CPU may be implemented on an FPGA, an ASIC or a PLD, or by using an individual logic circuit. The control part 16 is an example of the processor and the control part of the present disclosure. The control part 16 controls the execution of each operation and each process performed by the coin processing device 1. The control part 16 may be implemented as a plurality of processors that operates in conjunction with each other in parallel to execute the process instructions of the present disclosure.

The memory 17 stores a variety of information required for various operations of the coin processing device 1. Examples of the information stored in the memory 17 include a first denomination number information representing the number of coins per denomination stored in the first storage part 11 at that time point, and a second denomination number information representing the number of coins per denomination stored in the second storage part 12.

The inlet 21 is an opening that receives deposition from the outside of the coin processing device 1. The coin deposited from the inlet 21 is moved to the feeding part 13.

The outlet 22 is an opening that dispenses coins to the outside of the coin processing device 1.

The ejection mechanism 23 is a mechanism for ejecting coins from the first storage part 11 to the feeding part 13. The ejection mechanism 23 is a belt conveyor with a protrusion provided inside the first storage part 11. The belt conveyor is driven by a motor or the like to transport coins and eject the coins to the feeding part 13.

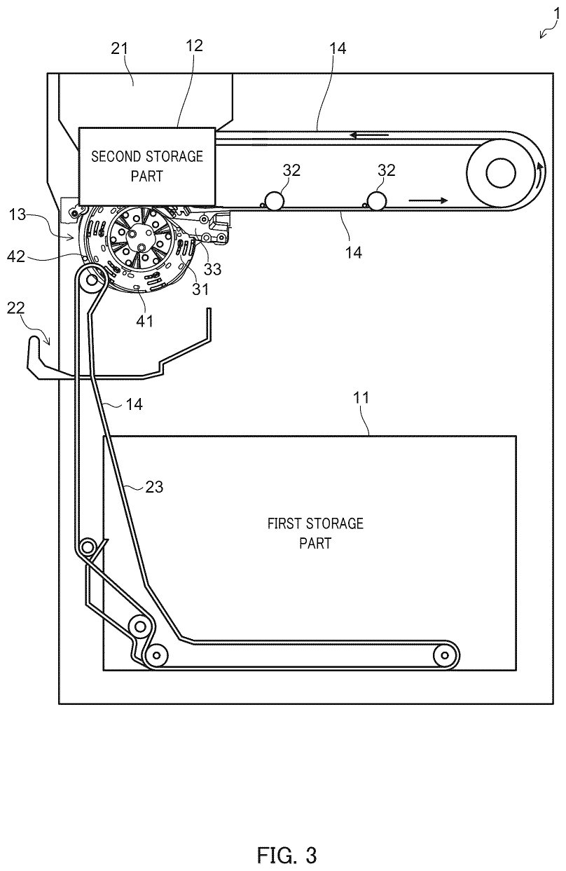

Next, a structure of the coin processing device 1 of the present disclosure is elaborated below. FIG. 3 is a diagram illustrating an example of a structure of the feeding part 13 of the present embodiment.

The feeding part 13 comprises a rotary disc 31 provided with a protrusion at the surface, for example. The rotary disc 31 is tilted at a predetermined angle with respect to the vertical direction, and is rotated in the tilted state by a motor or the like. The rotary disc 31 rotates clockwise.

When a coin 32 enters the feeding part 13, the coin 32 is stored in the space between the lower portion of the rotary disc 31 and the cover. Along with the rotation of the rotary disc 31, the coin 32 is caught by the protrusion one by one and moved to the upper side. The coin 32 caught by the protrusion and moved to the upper side is fed from a guide 33 provided on the outer periphery side of the rotary disc 31 in the feeding part 13. The guide 33 is connected to the transport part 14. With this configuration, the feeding part 13 can feed the coin 32 one by one to the transport path 14.

The rotary disc 31 of the feeding part 13 is provided next to the second storage part 12 on the lower side of the outlet of the feeding part 13. The second storage part 12 comprises an openable bottom portion, and when the bottom portion opens, the coin stored in the second storage part 12 falls into the feeding part 13 disposed immediately below the second storage part 12.

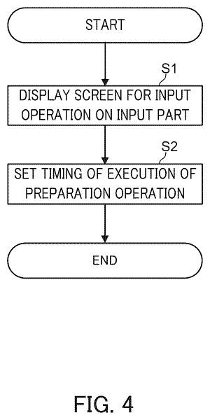

FIG. 4 is a flowchart illustrating an example of the setting procedure of the timing of execution of the preparation operation performed by the coin processing device 1. The flowchart of FIG. 4 is implemented when the control part 16 extracts the program stored in the memory 17 and controls each part. This flowchart is started when a setting menu is selected on the input part, for example. Alternatively, it may be started when the coin processing device 1 is activated.

Here, the timing of execution of the preparation operation can be changed in the period after the completion of the dispensing operation and before the start of the next dispensing operation.

This setting may be achieved by a managing server connected with the coin processing device 1 through a network or a mobile terminal carried by the managing user of the coin processing device 1, or may be achieved through an operation on the input operation part of the coin processing device 1. It may also be achieved through an operation on the input/output part 1a. The mobile terminal, the input operation part, and the input/output part 1a are examples of the input part.

First, the control part 16 of the coin processing device 1 causes any of the above-mentioned input parts to display the screen for the input operation to designate the timing of execution of the preparation operation (step S1).

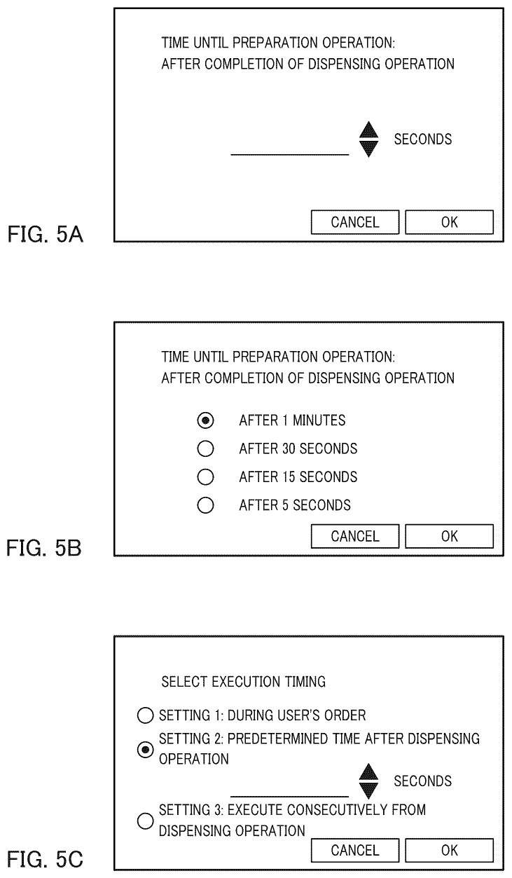

FIGS. 5A to 5C are examples of screen displays. As described above, the managing user can set the time that elapses until the start of the preparation operation after the completion of the dispensing operation. The control part 16 operates to display a screen for setting a given elapsed time (FIG. 5A), for example. It operates to display a screen for selection from among a plurality of predetermined elapsed times (FIG. 5B), for example.

Note that as described above, the setting may be selected from among a plurality of options. In that case, the control part 16 displays a plurality of options on the input part in a selectable manner (FIG. 5C).

The control part 16 acquires the information input to the input part, and performs the setting of the timing of execution of the preparation operation (step S2). The control part 16 stores the timing of execution of the preparation operation in the memory 17 on the basis of the acquired information, and terminates the setting.

The setting of the timing of execution of the preparation operation may be determined and executed by the coin processing device 1. In that case, it may acquire signals from various sensors to start the flowchart of FIG. 4 in response to a change in the surrounding environment.

Note that in this case the screen display of step S1 may not be performed, and the coin processing device 1 may determine the timing of the execution of the change preparation operation in accordance with the crowdedness of the store and the like as described above, and may automatically set the timing of the execution of the preparation operation at step S2. As described above, the setting can be changed on the basis of the dispensing frequency of the coin processing device 1, the crowdedness determination based on camera images, the determination of sound level by the sound sensor and the like, for example. The time elapsed until the start of the preparation operation from the completion of the dispensing operation is set on the basis of signals from various sensors. Alternatively, the timing of execution of the preparation operation is selected and set from among a plurality of options on the basis of signals from various sensors.

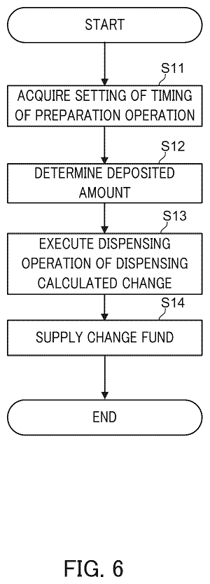

FIG. 6 is a flowchart illustrating an example of a processing procedure of the dispensing process performed by the coin processing device 1. The flowchart of FIG. 6 is implemented when the control part 16 extracts the program stored in the memory 17 and controls each part. This flowchart is started when the coin processing device 1 receives a depositing and dispensing instruction, for example. When the user 2 who is a customer of the store and a general user comes to the store, operates the coin processing device 1 to order and determine goods and the like, a depositing and dispensing instruction is sent to the coin processing device 1, for example.

When receiving the depositing and dispensing instruction, the control part 16 acquires from the memory 17 the setting of the timing of execution of the preparation operation (step S11).

Next, the money deposited from the inlet is received, the coin fed from the feeding part 13 is recognized by the recognition part 15, and the deposit amount is determined (step S12). In the case where a banknote processing device is provided in addition to the coin processing device 1, the deposit amount is determined together with the amount of the banknote deposited to the banknote processing device. The deposited coin is transported by the transport part 14 and stored in the first storage part 11.

After the deposit amount is determined, the control part 16 calculates the change to be given to the user 2 on the basis of the depositing and dispensing instruction and the determined deposit amount, and executes the dispensing operation of dispensing the calculated change (step S13).

Then, the control part 16 executes the preparation operation of transporting coins from the first storage part 11 to the second storage part 12 and supplying the change fund on the basis of the setting acquired at step S11 (step S14).

As described above, in Embodiment 1, the coin processing device 1 can change the timing of execution of the preparation operation in the period after the completion of the dispensing operation and before the start of the next dispensing operation.

Therefore, the administrator of the coin processing device 1 can set the preparation operation so as to be executed when the user 2's attention can be prevented from being drawn without lowering the speed of the change preparation operation.

Alternatively, the coin processing device 1 can automatically set the preparation operation so as to be executed when the user 2's attention can be prevented from being drawn without lowering the speed of the change preparation operation in accordance with the crowdedness of the store and the like.

Note that in the case where a plurality of the coin processing devices 1 is provided in a store, each coin processing device 1 may independently receive the setting of the execution of the preparation operation, and determine the execution of the preparation operation.

In addition, it is possible to adopt a setting in which after one coin processing device 1 receives the setting of the execution of the preparation operation and/or determines the execution of the preparation operation, another coin processing device 1 acquires that information and executes the preparation operation using the same setting as that of the one coin processing device 1.

### Second Embodiment

Next, the coin processing device 1 of a second embodiment is described. The coin processing device 1 of the second embodiment may have the same components as that illustrated in FIGS. 2 and 3. Therefore, the following description uses the configuration of the coin processing device 1 illustrated in FIGS. 2 and 3 as an example.

For example, foreign matters such as paper debris are often mistakenly input to the coin processing device 1 when the general user 2 inputs coins. The foreign matters input to the coin processing device 1 are stored in the feeding part 13 together with coins.

The feeding part 13 is provided with remaining object sensors 41 and 42 that detect remaining coins and foreign matters. The remaining object sensors 41 and 42 are sensors that detect whether there is a remaining coin or foreign matter on the light path on the basis of whether light emitted from a light projecting part is delivered to the light reception part without being blocked by a coin or foreign matter, for example.

When a remaining coin or foreign matter is detected by the remaining object sensors 41 and 42, the coin processing device 1 performs an elimination operation of returning the remaining coin or foreign matter to the user 2 after the depositing process. In the case where the foreign matter is paper debris, the foreign matter may remain without being caught by the protrusion of the rotary disc 31, and in that case, the foreign matter cannot be eliminated, finally causing errors.

In the second embodiment, the control part 16 determines which of a coin and a foreign matter such as paper debris is remaining on the basis of the light shield status of the remaining object sensor 42.

The remaining coins can be detected by the remaining object sensor 41 and the remaining object sensor 42. It should be noted that when there is a remaining coin, the remaining object sensor 42 repeats transmission and shielding because the coin can be caught by the protrusion of the rotary disc 31 and can be detached from the protrusion.

On the other hand, paper debris does not block light at the remaining object sensor 41, or even when it blocks light, it is located above the foreign matter elimination gate at the position of the remaining object sensor 41, and therefore can be eliminated through the elimination operation. At the remaining object sensor 42, the remaining paper debris is retained without being caught by the protrusion of the rotary disc 31, thus continuing to block the light emitted by light projecting part.

Therefore, when light is continuously blocked at the remaining object sensor 42 for a predetermined time or longer, the control part 16 temporarily handles it as an occurrence of a remaining error. When light is continuously blocked at the remaining object sensor 42 for a predetermined time or longer, it is regarded as a fact that there is remaining paper debris.

Thereafter, the control part 16 determines whether to determine the above-mentioned remaining error to be an error, or ignore it, in accordance with the details of the process to be executed. Note that when it is determined to be an error, the coin processing device 1 stops the operation, and an error is notified to the managing user.

For example, the control part 16 ignores the above-mentioned remaining error in the case of the process that is operated by the user 2 who is a general user such as the depositing process and the dispensing process.

In this manner, no error is caused even when paper debris is input, and the coin processing device 1 continues to normally move. The coin feeding process is not affected even such foreign matters as paper debris remain.

Note that in the case where paper debris continuously blocks the light for a predetermined time or longer at the remaining object sensor 42, the coin remaining detection cannot be performed at the remaining object sensor 42, but the remaining object sensor 41 performs the coin remaining detection as usual. After the remaining object sensor 42 is set to a light shielding state continuously for a predetermined time or longer, the remaining coins are detected with the output of the remaining object sensor 41 until the error releasing operation described later is performed.

On the other hand, the control part 16 determines the error to be an error in the case of a process that is performed by the managing user of the coin processing device 1, such as replenishment of coins, scrutiny counting of the number of deposited coins and the like, and a resetting process of resetting the coin processing device 1.

According to the second embodiment, usability is improved because the coin processing device 1 does not stop due to errors even when the remaining object sensor 42 has detected paper debris that less affects the feeding operation of the coin from the feeding part 13 and is difficult to be eliminated by the foreign matter elimination operation.

In the case of a process performed by the managing user of the coin processing device 1, the above-mentioned remaining error can be determined to be an error so as to prompt the managing user of the coin processing device 1 to perform an error releasing operation for removing the paper debris.

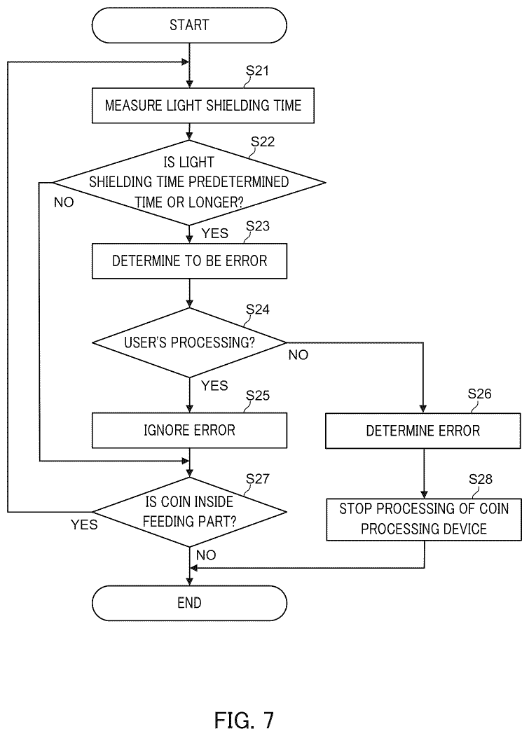

FIG. 7 is a flowchart illustrating an example of a processing procedure of an error determination process performed by the coin processing device 1. The flowchart of FIG. 7 is implemented when the control part 16 extracts the program stored in the memory 17 and controls each part. This flowchart is started when a coin is input to the feeding part 13 in the coin processing device 1, for example. For example, it is determined that a coin is input to the feeding part 13 with the output of the remaining object sensor 41 or the remaining object sensor 42.

First, the control part 16 of the coin processing device 1 measures the light shielding time during which light emitted from a light projecting part is blocked at the remaining object sensor 42 (step S21).

Then, the control part 16 determines whether the light shielding time is a predetermined time or longer (step S22). When the light shielding time is a predetermined time or longer (step S22, YES), the control part 16 determines that there is an occurrence of a remaining error of remaining paper debris (step S23). When the light shielding time is shorter than the predetermined time (step S22, NO), the process proceeds to step S27.

When it is determined that there is an occurrence of remaining error at step S23, the control part 16 determines whether the details of the process at the time of the occurrence of the remaining error is a process that is operated by the user 2 who is a general user (step S24).

When the details of the process are a process operated by the user 2 (step S24, YES), the control part 16 ignores the remaining error occurred (step S25).

Thereafter, it is determined whether there is a coin inside the feeding part 13 (step S27), and when there is a coin (step S27, YES), the process is returned to step S21. When all coins inside the feeding part 13 are fed and it is emptied (step S27, NO), the process under execution is normally completed.

When the details of the process are not a process operated by the user 2 who is a general user, but is a process operated by the managing user of the coin processing device 1 (step S24, NO), the control part 16 determines the remaining error occurred to be an error (step S26).

When it is determined to be an error, the process proceeds to step S28, and the operation of the coin processing device 1 is stopped. The control part 16 notifies the managing user of the error, and then this flowchart is terminated.

As described above, in Embodiment 2, when a remaining object for which the remaining object sensor provides a predetermined output is detected, whether it is determined to be a remaining error is determined in accordance with the details of the process to be executed, and as such the coin processing device 1 is not stopped so as to continue the process for a process that causes no problem even when the process is continued, and thus, the usability can be improved. For example, stop of the device due to a remaining error that does not affect the operation such as remaining paper debris can be reduced.

Note that the present embodiments are not limited to the above-described embodiments, but can be modified as needed without departing from the gist. The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This application is entitled to and claims the benefit of Japanese Patent Application No. 2023-108398 filed on Jun. 30, 2023, the disclosure each of which including the specification, drawings and abstract is incorporated herein by reference in its entirety.

1. A coin processing device, comprising:
a first storage and a second storage each configured to store a coin;
a transport configured to transport the coin;
an outlet configured to dispense the coin to outside; and
a controller configured to execute a first operation of transmitting the coin stored in the first storage so as to store the coin in the second storage, and a second operation of dispensing the coin stored in the second storage from the outlet,
wherein the controller executes the first operation in a period after execution of the second operation until a start of the next second operation, and
wherein a timing of execution of the first operation can be changed in a period after execution of the second operation until a start of the next second operation.

2. The coin processing device according to claim 1, wherein the controller acquires information about a timing of execution of the first operation input by a user through an input part, and sets the timing of execution of the first operation in accordance with the information acquired.

3. The coin processing device according to claim 2, wherein the controller causes the input part to display a screen configured to input a time from completion of the second operation to a start of the first operation.

4. The coin processing device according to claim 2, wherein the controller causes the input part to display a time from completion of the second operation to a start of the first operation in a selectable manner from among a plurality of predetermined times.

5. The coin processing device according to claim 2, wherein the controller causes the input part to display the information about the timing of execution of the first operation in a selectable manner from among a plurality of options.

6. The coin processing device according to claim 5, wherein as the plurality of options, the controller causes the input part to display in a selectable manner at least
execution of the first operation after an elapse of a predetermined time after completion of the second operation, or
execution of the first operation consecutively from the second operation.

7. The coin processing device according to claim 5, wherein:
the controller acquires information about an input of the user on an order input part configured to receive an input for transaction, and
as the plurality of options, the controller causes the input part to display in a selectable manner at least execution of the first operation while the user performs input on the order input part.

8. The coin processing device according to claim 1, wherein the controller sets a time until a start of the first operation after the second operation.

9. The coin processing device according to claim 1, wherein the controller sets the timing of execution of the first operation from among a plurality of options.

10. The coin processing device according to claim 4, wherein the controller sets execution of the first operation after an elapse of a predetermined time after completion of the second operation.

11. The coin processing device according to claim 1, wherein the controller sets execution of the first operation consecutively from the second operation.

12. The coin processing device according to claim 1, wherein the controller sets the timing of execution of the first operation in accordance with frequency of the second operation.

13. The coin processing device according to claim 12,
wherein in a case where the frequency is lower than a predetermined level, the controller executes the first operation when a predetermined time has elapsed after completion of the second operation, and
wherein in a case where the frequency is higher than the predetermined level, the controller executes the first operation consecutively from the second operation.

14. The coin processing device according to claim 1, further comprising:
a feeding part configured to feed the coin to the transport path; and
a sensor disposed at the feeding part and configured to detect a remaining object inside the feeding part,
wherein when the remaining object is detected by the sensor, the controller determines whether to determine the remaining object to be an error in accordance with details of a process that is being executed.

15. A method of controlling a coin processing device, comprising:
performing a first operation to store, from a first storage configured to store coins, at least some of the coins in a second storage by transporting the at least some of the coins from the first storage; and
performing a second operation to dispense from an outlet at least some of coins stored in the second storage,
wherein the first operation is executed in a period after execution of the second operation until a start of the next second operation, and
wherein a timing of execution of the first operation can be changed in a period after execution of the second operation until a start of the next second operation.
